(19) United States
(12) Patent Application Publication
(10) Pub. No.: US 2026/0036787 A1
(43) Pub. Date: Feb. 5, 2026

(54) IMAGING LENS AND ELECTRONIC DEVICE

(71) Applicant: LARGAN PRECISION CO., LTD., Taichung City (TW)

(72) Inventor: Chen Wei FAN, Taichung City (TW)

(73) Assignee: LARGAN PRECISION CO., LTD., Taichung City (TW)

(21) Appl. No.: 19/235,740

(22) Filed: Jun. 12, 2025

(30) Foreign Application Priority Data
Jul. 31, 2024 (TW) 113128521

(51) Int. Cl. G02B 13/00; G02B 1/04; G02B 7/02

(52) U.S. Cl. CPC G02B 13/004; G02B 1/041; G02B 7/021; G02B 7/022

(57) ABSTRACT

An imaging lens includes a plastic lens element having a central axis and including an optically effective portion and a peripheral portion adjacently disposed around the optically effective portion. The peripheral portion includes a first side surface and a second side surface disposed opposite each other in a direction of the central axis, and includes a connection surface farther away from the central axis than the first side surface and the second side surface. The first side surface and/or the second side surface has a structural region. The plastic lens element further includes multiple columnar protrusions arranged in a two-dimensional array in the structural region, connected to the structural region and extending protrusively away from the structural region. Each columnar protrusion has a bottom part connected to the structural region and a top part having an arcuate surface. A contour of the bottom part is circular-shaped.

### RELATED APPLICATIONS

This application claims priority to Taiwan Application 113128521, filed on Jul. 31, 2024, which is incorporated by reference herein in its entirety.

### BACKGROUND

### Technical Field

The present disclosure relates to an imaging lens and an electronic device, more particularly to an imaging lens applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an optical system nowadays. Furthermore, due to the rapid changes in technology, smartphone devices equipped with optical systems are trending towards multi-functionality for various applications, and therefore the functionality requirements for the optical systems have been increasing.

In recent years, it has become increasingly popular to use miniature optical systems in mobile devices for photography. However, mobile devices are often affected by intense sunlight during outdoor use, causing the optical systems to be significantly impacted by strong non-imaging stray light. Especially the non-imaging light easily reflects within the optical systems, greatly reducing image quality.

Conventional techniques for optical systems involve methods such as inking, sandblasting, and coating the surfaces of optical elements to reduce reflectivity and eliminate stray light. Although these methods can improve optical image quality, they are still insufficient for eliminating high-intensity stray light. Furthermore, in the field of non-mobile device optical systems, there are other techniques for reducing reflectivity, such as forming porous microstructures on the surface of coatings. However, the structures lack sufficient support and are prone to deformation due to environmental factors, which significantly reduces anti-reflective effectiveness. Therefore, improving the structure of internal components in optical systems to reduce the reflection intensity of non-imaging light has become a critical issue in meeting the high-end requirements for electronic devices nowadays.

### SUMMARY

According to one aspect of the present disclosure, an imaging lens includes a plastic lens element. The plastic lens element has a central axis, and the plastic lens element includes an optically effective portion and a peripheral portion. The central axis passes through a center of the optically effective portion. The peripheral portion is adjacently disposed around the optically effective portion, and the peripheral portion includes a first side surface, a second side surface and a connection surface. The second side surface is disposed opposite to the first side surface in a direction parallel to the central axis. The connection surface is connected to the first side surface and the second side surface, and the connection surface is located farther away from the central axis than the first side surface and the second side surface. In addition, at least one of the first side surface and the second side surface has a structural region. The plastic lens element further includes a plurality of columnar protrusions, and the columnar protrusions are disposed in the structural region and arranged in a two-dimensional array. The columnar protrusions are connected to the structural region and extend protrusively away from the structural region. Each of the columnar protrusions has a bottom part and a top part that are opposite to each other. A contour of each of the bottom parts is circular-shaped, the bottom parts are connected to the structural region, and each of the top parts has an arcuate surface. Additionally, when a projected area of the structural region on a plane perpendicular to the central axis is A1, and a number of the plurality of columnar protrusions is N1, the following condition is satisfied: 250 mm⁻²<N1/A1<1500 mm⁻².

According to another aspect of the present disclosure, an electronic device includes the aforementioned imaging lens and an image sensor disposed on an image surface of the imaging lens.

### BRIEF DESCRIPTION OF THE DRAWINGS

The disclosure can be better understood by reading the following detailed description of the embodiments, with reference made to the accompanying drawings as follows:

FIG. 1 is a cross-sectional view of an imaging lens according to the 1st embodiment of the present disclosure;

FIG. 2 is an enlarged view of region EL2 in FIG. 1;

FIG. 3 is a perspective view of a first plastic lens element in FIG. 1;

FIG. 4 is an enlarged view of region EL4 in FIG. 3;

FIG. 5 is a top view of the first plastic lens element in FIG. 1;

FIG. 6 is a cross-sectional view of the first plastic lens element taken along line 6-6 in FIG. 5;

FIG. 7 is an enlarged view of region EL7 in FIG. 1;

FIG. 8 is an enlarged view of region EL8 in FIG. 1;

FIG. 9 is a perspective view of a second plastic lens element in FIG. 1;

FIG. 10 is an enlarged view of region EL10 in FIG. 9;

FIG. 11 is a top view of the second plastic lens element in FIG. 1;

FIG. 12 is a cross-sectional view of the second plastic lens element taken along line 12-12 in FIG. 11;

FIG. 13 is an enlarged view of region EL13 in FIG. 12;

FIG. 14 is an enlarged view of region EL14 in FIG. 1;

FIG. 15 is a perspective view of a third plastic lens element in FIG. 1;

FIG. 16 is an enlarged view of region EL16 in FIG. 15;

FIG. 17 is a top view of the third plastic lens element in FIG. 1;

FIG. 18 is a cross-sectional view of the third plastic lens element taken along line 18-18 in FIG. 17;

FIG. 19 is an enlarged view of region EL19 in FIG. 18;

FIG. 20 is a cross-sectional view of an imaging lens according to the 2nd embodiment of the present disclosure;

FIG. 21 is an enlarged view of region EL21 in FIG. 20;

FIG. 22 is a perspective view of a plastic lens element in FIG. 20;

FIG. 23 is an enlarged view of region EL23 in FIG. 22;

FIG. 24 is a bottom view of the plastic lens element in FIG. 20;

FIG. 25 is a cross-sectional view of the plastic lens element taken along line 25-25 in FIG. 24;

FIG. 26 is an enlarged view of region EL26 in FIG. 20;

FIG. 27 is a cross-sectional view of an imaging lens according to the 3rd embodiment of the present disclosure;

FIG. 28 is an enlarged view of region EL28 in FIG. 27;

FIG. 29 is a perspective view of a plastic lens element in FIG. 27;

FIG. 30 is an enlarged view of region EL30 in FIG. 29;

FIG. 31 is a top view of the plastic lens element in FIG. 27;

FIG. 32 is a cross-sectional view of the plastic lens element taken along line 32-32 in FIG. 31;

FIG. 33 is an enlarged view of region EL33 in FIG. 32;

FIG. 34 is a perspective view of an electronic device according to the 4th embodiment of the present disclosure;

FIG. 35 is another perspective view of the electronic device in FIG. 34;

FIG. 36 is an illustration of an image captured by an ultra-wide-angle camera module;

FIG. 37 is an illustration of an image captured by a high pixel camera module;

FIG. 38 is an illustration of an image captured by a telephoto camera module;

FIG. 39 is a perspective view of an electronic device according to the 5th embodiment of the present disclosure;

FIG. 40 is a perspective view of an electronic device according to the 6th embodiment of the present disclosure;

FIG. 41 is a side view of the electronic device in FIG. 40; and

FIG. 42 is a top view of the electronic device in FIG. 40.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an imaging lens. The imaging lens includes a plastic lens element. The plastic lens element has a central axis, and the plastic lens element includes an optically effective portion and a peripheral portion. In addition, the central axis passes through a center of the optically effective portion, and the peripheral portion is adjacently disposed around the optically effective portion.

The peripheral portion includes a first side surface, a second side surface and a connection surface. The second side surface is disposed opposite to the first side surface in a direction parallel to the central axis. The connection surface is connected to the first side surface and the second side surface, and the connection surface is located farther away from the central axis than the first side surface and the second side surface. In addition, at least one of the first side surface and the second side surface has a structural region. The first side surface and the second side surface can, for example, respectively face an object side and an image side of the imaging lens, but the present disclosure is not limited thereto.

The plastic lens element further includes a plurality of columnar protrusions disposed in the structural region and arranged in a two-dimensional array. In addition, the two-dimensional array can, for example, be a circular array, a linear array, or a curved array, but the present disclosure is not limited thereto. The extent of the structural region can be defined by the arrangement range of the columnar protrusions. For example, when the columnar protrusions are arranged in a circular array on the first side surface or the second side surface, the innermost columnar protrusions can define an inscribed circle, and the outermost columnar protrusions can define a circumscribed circle. Thus, the area formed between the inscribed circle and the circumscribed circle defines the extent of the structural region.

The columnar protrusions are connected to the structural region and extend protrusively away from the structural region. In addition, each of the columnar protrusions has a bottom part and a top part that are opposite to each other. A contour of each of the bottom parts is circular-shaped, the bottom parts are connected to the structural region, and each of the top parts has an arcuate surface. Therefore, the circular-shaped configuration of the contour of the bottom part of the columnar protrusions is favorable for reducing stray light between the columnar protrusions, and the circular-shaped configuration of the top part is favorable for the manufacturing and forming of the columnar protrusions. The circular-shaped contour of the bottom part can, for example, refer to the cross-section of the bottom part being circular or elliptical, but the present disclosure is not limited thereto. The arcuate surface of the top part can, for example, be spherical or ellipsoidal, but the present disclosure is not limited thereto.

When a projected area of the structural region on a plane perpendicular to the central axis is A1, and the number of the columnar protrusions is N1, the following condition is satisfied: 250 mm⁻²<N1/A1<1500 mm⁻². Therefore, arranging the columnar protrusions at an appropriate density is favorable for achieving a better stray light attenuation effect. Moreover, the following condition can also be satisfied: 450 mm⁻²<N1/A1<1100 mm⁻². Moreover, the following condition can also be satisfied: 500 mm⁻²<N1/A1<800 mm⁻².

When the number of the columnar protrusions is N1, the following condition can be satisfied: 746<N1<4500. Therefore, arranging the columnar protrusions in an appropriate quantity is favorable for achieving a better stray light attenuation effect. Moreover, the following condition can also be satisfied: 783<N1<2330. Moreover, the following condition can also be satisfied: 814<N1<1513.

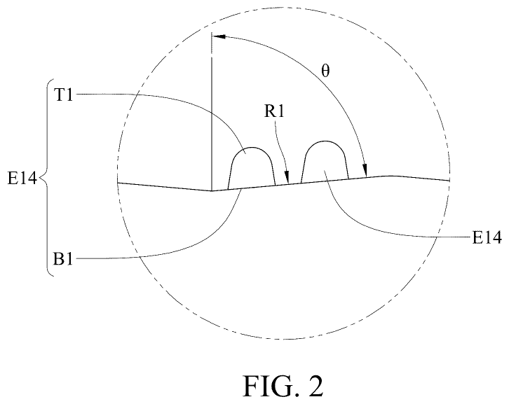

When an angle between a surface of the structural region and the central axis is θ, the following condition can be satisfied: 0.86<sin θ≤1. Therefore, an appropriate angular parameter is favorable for the entry of stray light into a space between the columnar protrusions in the structural region, allowing the stray light to be reduced between the columnar protrusions, and also favorable for improving the molding quality of the columnar protrusions. Moreover, the following condition can also be satisfied: 0.96<sin θ<1. Please refer to FIG. 2, which shows a schematic view of θ according to the 1st embodiment of the present disclosure.

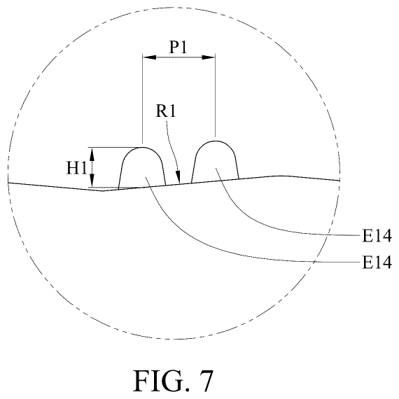

When a protrusion height of each of the columnar protrusions in a direction parallel to the central axis is H1, and a distance between any two adjacent ones of the columnar protrusions is P1, the following condition can be satisfied: 0.2<H1/P1<0.8. Therefore, it is favorable for the reduction of stray light between the columnar protrusions. Moreover, the following condition can also be satisfied: 0.4<H1/P1<0.67. The protrusion height can refer to a height at which a center of a single columnar protrusion extends from the structural region in a direction parallel to the central axis, and the distance between adjacent columnar protrusions can refer to a distance between a center of one columnar protrusion and a center of an adjacent columnar protrusion. Please refer to FIG. 7, which shows a schematic view of H1 and P1 according to the 1st embodiment of the present disclosure.

A direction in which each of the columnar protrusions extends from the structural region can be parallel to the central axis. Therefore, it is favorable for improving the molding quality of the columnar protrusions.

According to the present disclosure, the imaging lens can further include an optical element, the optical element is disposed adjacent to the plastic lens element, and the top parts of the columnar protrusions of the plastic lens element can be in physical contact with the optical element. Therefore, it is favorable for buffering the bearing stress between the optical element and the plastic lens element to prevent deformation of the plastic lens element or the optical element. The optical element can be, for example, a barrel, a lens element, a light-blocking element, a spacer, or a retainer or a filter, but the present disclosure is not limited thereto.

The plastic lens element can further include a light-absorbing coating, and the light-absorbing coating can cover the structural region and reduce light reflection. Therefore, it is favorable for further reducing the possibility of stray light reflection.

A surface of each other columnar protrusions can be a smooth surface. Therefore, it is favorable for preventing damage to the optical element adjacent to the plastic lens element, thereby preventing any impact on lens element assembly accuracy.

According to the present disclosure, the imaging lens can further include an adhesive element configured for securing the plastic lens element, and the columnar protrusions can be in physical contact with the adhesive element. Therefore, it is favorable for preventing the adhesive element from overflowing and affecting other areas (e.g., the optically effective portion).

According to the present disclosure, an electronic device is provided. The electronic device includes an image sensor and the aforementioned imaging lens, and the image sensor is disposed on an image surface of the imaging lens.

According to the present disclosure, the aforementioned features and conditions can be utilized in numerous combinations so as to achieve corresponding effects.

According to the above description of the present disclosure, the following specific embodiments are provided for further explanation.

### 1st Embodiment

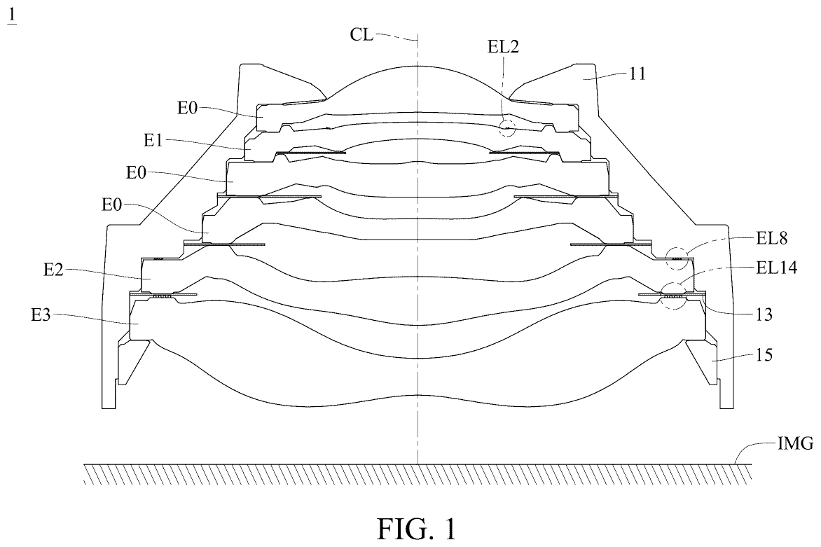

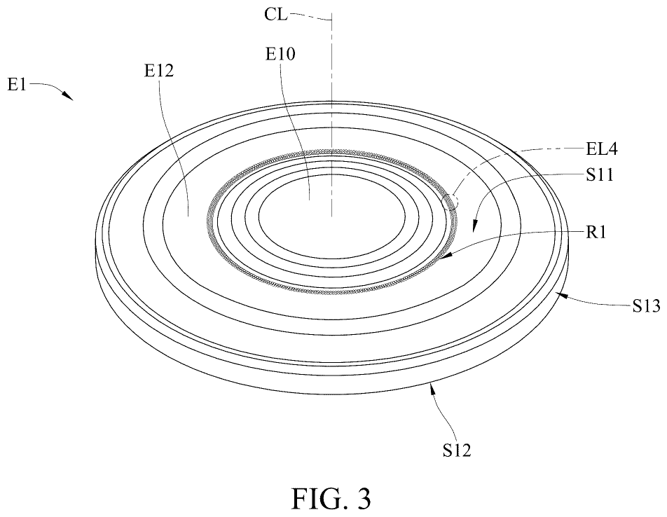

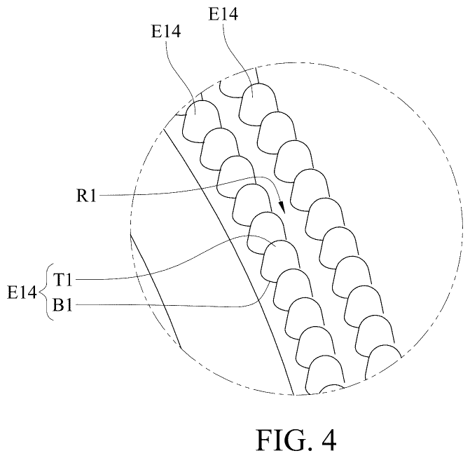

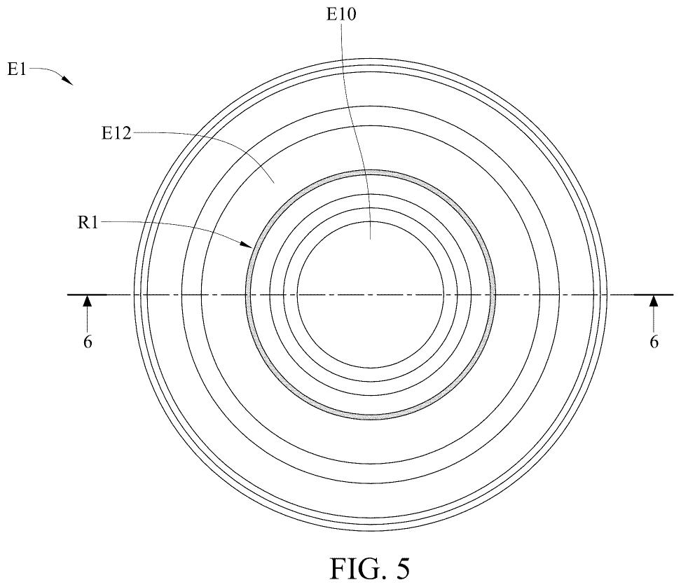

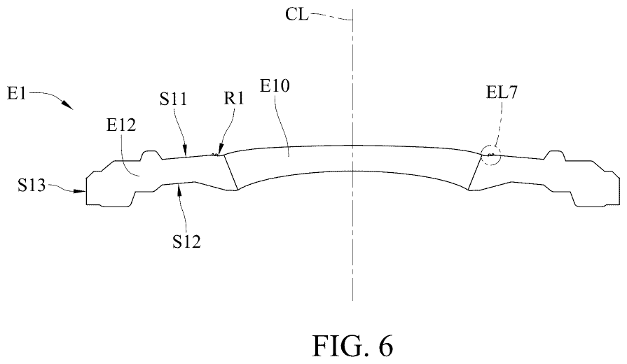

FIG. 1 is a cross-sectional view of an imaging lens according to the 1st embodiment of the present disclosure, FIG. 2 is an enlarged view of region EL2 in FIG. 1, FIG. 3 is a perspective view of a first plastic lens element in FIG. 1, FIG. 4 is an enlarged view of region EL4 in FIG. 3, FIG. 5 is a top view of the first plastic lens element in FIG. 1, FIG. 6 is a cross-sectional view of the first plastic lens element taken along line 6-6 in FIG. 5, and FIG. 7 is an enlarged view of region EL7 in FIG. 1.

An imaging lens 1 is provided in this embodiment. The imaging lens 1 includes a barrel 11, a plurality of lens elements E0, E1, E2 and E3, a light-blocking element 13, a retainer 15 and an image surface IMG. The lens elements E0, E1, E2 and E3, the light-blocking element 13 and the retainer 15 are accommodated in the barrel 11, and after entering the barrel 11, light passes through the lens elements E0, E1, E2 and E3, the light-blocking element 13 and the retainer 15 to form imaging light, which is then focused onto the image surface IMG.

The lens elements E0, E1, E2 and E3 include a first plastic lens element E1, a second plastic lens element E2 and a third plastic lens element E3. The third plastic lens element E3 is located closer to the image surface IMG than the first plastic lens element E1, and the second plastic lens element E2 is located between the first plastic lens element E1 and the third plastic lens element E3.

The light-blocking element 13 is disposed adjacent to the third plastic lens element E3, and the light-blocking element 13 is located between the second plastic lens element E2 and the third plastic lens element E3. Moreover, the light-blocking element 13 is configured to block non-imaging light.

The retainer 15 is in physical contact with the third plastic lens element E3, and the retainer 15 is configured to secure the lens elements E0, E1, E2 and E3.

As shown in FIG. 3, FIG. 5 and FIG. 6, the first plastic lens element E1 has a central axis CL, and the first plastic lens element E1 includes an optically effective portion E10, a peripheral portion E12 and a plurality of columnar protrusions E14. In addition, the central axis CL passes through a center of the optically effective portion E10, and the peripheral portion E12 is adjacently disposed around the optically effective portion E10.

The peripheral portion E12 includes a first side surface S11, a second side surface S12 and a connection surface S13. The second side surface S12 is disposed opposite to the first side surface S11 in a direction parallel to the central axis CL. The connection surface S13 are connected to the first side surface S11 and the second side surface S12, and the connection surface S13 is located farther away from the central axis CL than the first side surface S11 and the second side surface S12. In addition, the first side surface S11 has a structural region R1.

As shown in FIG. 3 to FIG. 5, the columnar protrusions E14 are disposed in the structural region R1 and arranged in a two-dimensional array. Moreover, the columnar protrusions E14 are arranged in a two-dimensional circular array.

As shown in FIG. 2, FIG. 6 and FIG. 7, the columnar protrusions E14 are connected to the structural region R1 and extend protrusively away from the structural region R1. In detail, each of the columnar protrusions E14 has a bottom part B1 and a top part T1 that are opposite to each other. A contour of each of the bottom parts B1 is circular-shaped, the bottom parts B1 are connected to the structural region R1, and each of the top parts T1 has an arcuate surface. In addition, a direction in which each of the columnar protrusions E14 extends from the structural region R1 is parallel to the central axis CL, and a surface of each of the columnar protrusions E14 is a smooth surface.

When the number of the columnar protrusions E14 is N1, the following condition is satisfied: N1=300×2=600 (300 per ring, with a total of 2 rings).

As shown in FIG. 5, when a projected area of the structural region R1 on a plane perpendicular to the central axis CL is A1, and the number of the columnar protrusions E14 is N1, the following conditions are satisfied: A1=0.5564 mm²; N1=600; and N1/A1=1078.36 mm⁻².

As shown in FIG. 2, when an angle between a surface of the structural region R1 and the central axis CL is θ, the following conditions are satisfied: θ=85°; and sin θ=0.996.

As shown in FIG. 7, when a protrusion height of each of the columnar protrusions E14 in a direction parallel to the central axis CL is H1, and a distance between any two adjacent ones of the columnar protrusions E14 is P1, the following conditions are satisfied: H1=0.02 mm; P1=0.0364 mm; and H1/P1=0.55.

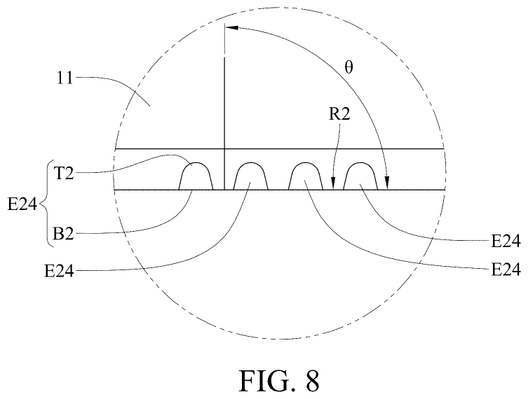

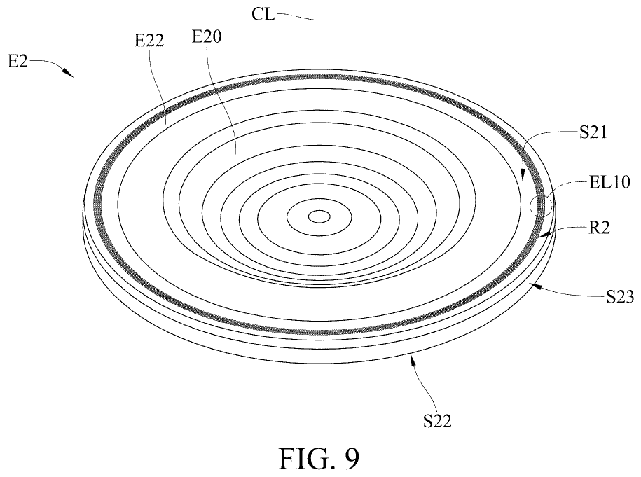

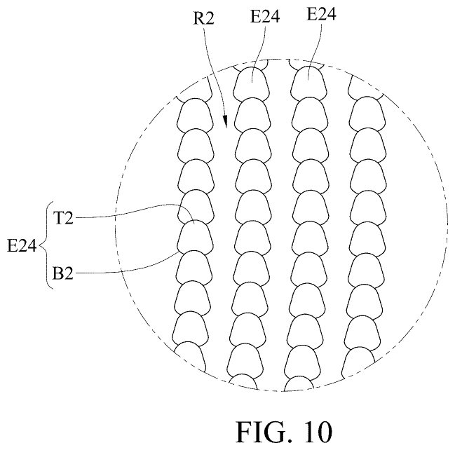

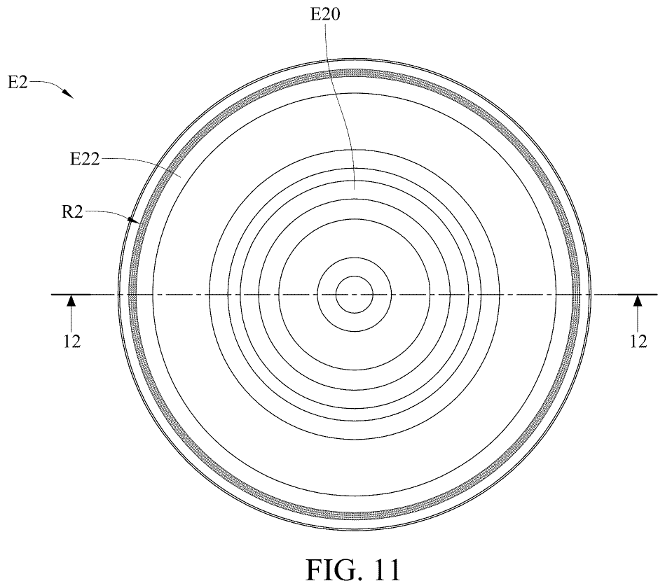

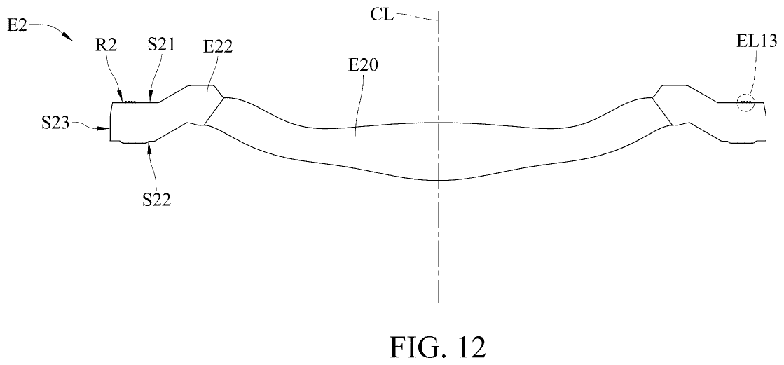

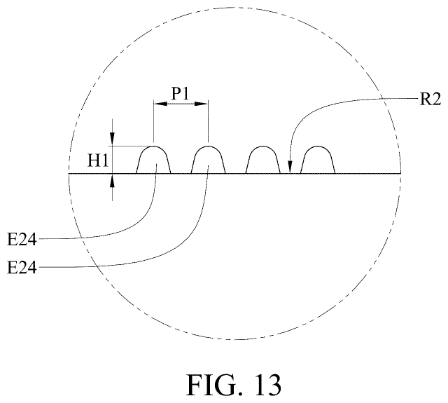

In this embodiment, in addition to the first plastic lens element E1 as described above, the second plastic lens element E2 can also be provided with columnar protrusions. Specifically, referring to FIG. 8 to FIG. 13, FIG. 8 is an enlarged view of region EL8 in FIG. 1, FIG. 9 is a perspective view of a second plastic lens element in FIG. 1, FIG. 10 is an enlarged view of region EL10 in FIG. 9, FIG. 11 is a top view of the second plastic lens element in FIG. 1, FIG. 12 is a cross-sectional view of the second plastic lens element taken along line 12-12 in FIG. 11, and FIG. 13 is an enlarged view of region EL13 in FIG. 12.

As shown in FIG. 9, FIG. 11 and FIG. 12, the second plastic lens element E2 has a central axis CL, and the second plastic lens element E2 includes an optically effective portion E20, a peripheral portion E22 and a plurality of columnar protrusions E24. In addition, the central axis CL passes through a center of the optically effective portion E20, and the peripheral portion E22 is adjacently disposed around the optically effective portion E20.

The peripheral portion E22 includes a first side surface S21, a second side surface S22 and a connection surface S23. The second side surface S22 is disposed opposite to the first side surface S21 in a direction parallel to the central axis CL. The connection surface S23 is connected to the first side surface S21 and the second side surface S22, and the connection surface S23 is located farther away from the central axis CL than the first side surface S21 and the second side surface S22. In addition, the first side surface S21 has a structural region R2.

As shown in FIG. 9 to FIG. 11, the columnar protrusions E24 are disposed in the structural region R2 and arranged in a two-dimensional array. Moreover, the columnar protrusions E24 are arranged in a two-dimensional circular array.

As shown in FIG. 8, FIG. 12 and FIG. 13, the columnar protrusions E24 are connected to the structural region R2 and extend protrusively away from the structural region R2. In detail, each of the columnar protrusions E24 has a bottom part B2 and a top part T2 that are opposite to each other. A contour of each of the bottom parts B2 is circular-shaped, the bottom parts B2 are connected to the structural region R2, and each of the top parts T2 has an arcuate surface. In addition, a direction in which each of the columnar protrusions E24 extends from the structural region R2 is parallel to the central axis CL, and a surface of each of the columnar protrusions E24 is a smooth surface.

When the number of the columnar protrusions E24 is N1, the following condition is satisfied: N1=720×4=2880 (720 per ring, with a total of 4 rings).

As shown in FIG. 11, when a projected area of the structural region R2 on a plane perpendicular to the central axis CL is A1, and the number of the columnar protrusions E24 is N1, the following conditions are satisfied: A1=3.8951 mm²; N1=2880; and N1/A1=739.39 mm⁻².

As shown in FIG. 8, when an angle between a surface of the structural region R2 and the central axis CL is θ, the following conditions are satisfied: θ=90°; and sin θ=1.

As shown in FIG. 13, when a protrusion height of each of the columnar protrusions E24 in a direction parallel to the central axis CL is H1, and a distance between any two adjacent ones of the columnar protrusions E24 is P1, the following conditions are satisfied: H1=0.02 mm; P1=0.04 mm; and H1/P1=0.5.

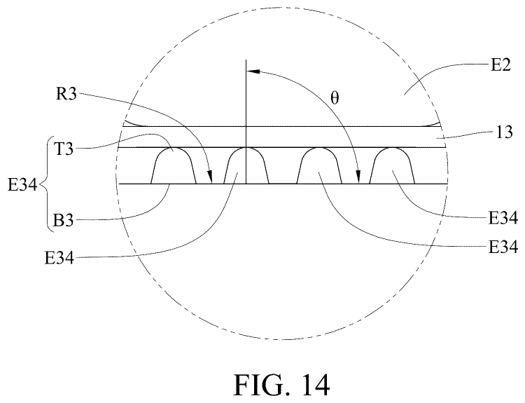

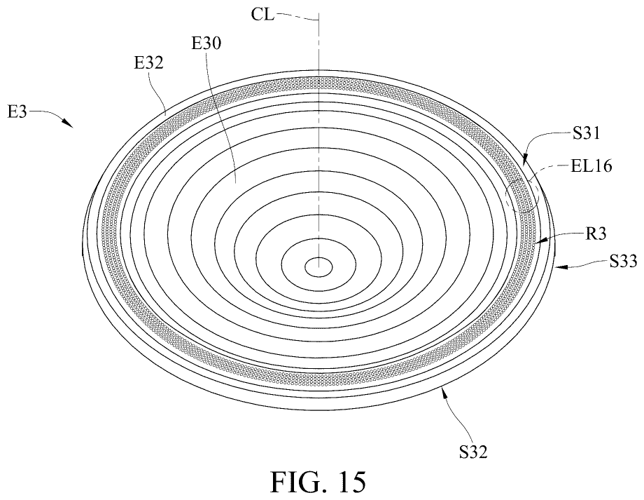

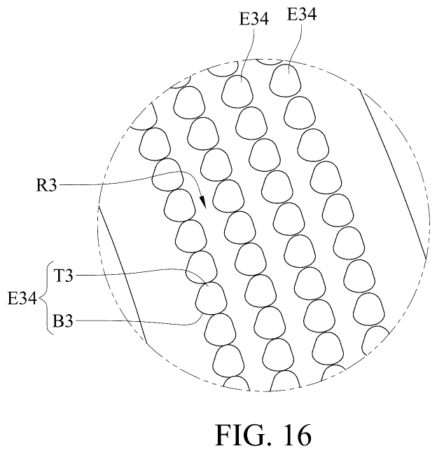

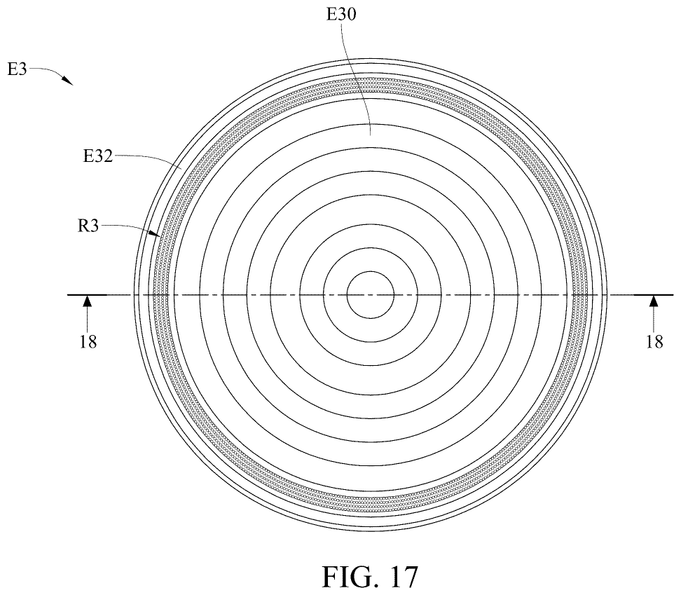

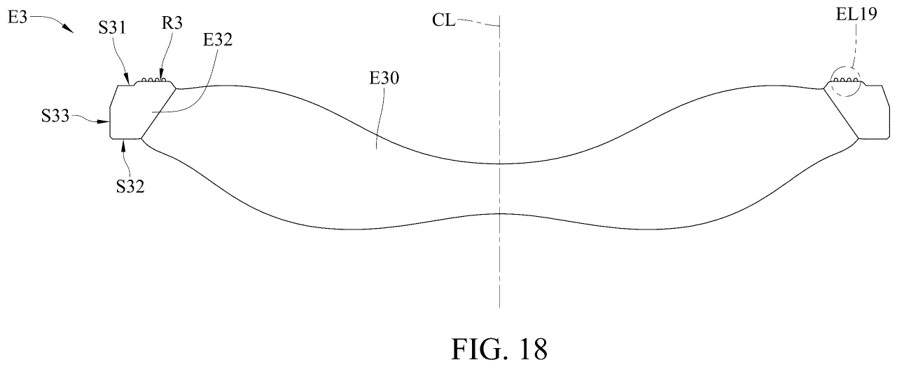

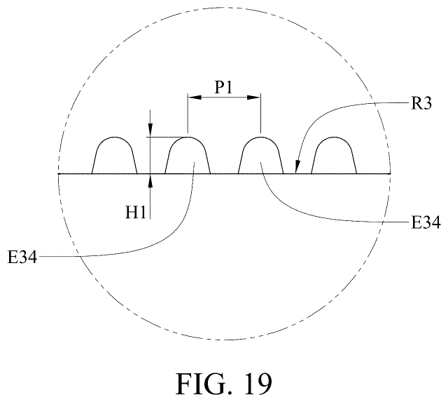

In this embodiment, in addition to the first plastic lens element E1 and the second plastic lens element E2 as described above, the third plastic lens element E3 can also be provided with columnar protrusions. Specifically, referring to FIG. 14 to FIG. 19, FIG. 14 is an enlarged view of region EL14 in FIG. 1, FIG. 15 is a perspective view of a third plastic lens element in FIG. 1, FIG. 16 is an enlarged view of region EL16 in FIG. 15, FIG. 17 is a top view of the third plastic lens element in FIG. 1, FIG. 18 is a cross-sectional view of the third plastic lens element taken along line 18-18 in FIG. 17, and FIG. 19 is an enlarged view of region EL19 in FIG. 18.

As shown in FIG. 15, FIG. 17 and FIG. 18, the third plastic lens element E3 has a central axis CL, and the third plastic lens element E3 includes an optically effective portion E30, a peripheral portion E32 and a plurality of columnar protrusions E34. In addition, the central axis CL passes through a center of the optically effective portion E30, and the peripheral portion E32 is adjacently disposed around the optically effective portion E30.

The peripheral portion E32 includes a first side surface S31, a second side surface S32 and a connection surface S33. The second side surface S32 is disposed opposite to the first side surface S31 in a direction parallel to the central axis CL. The connection surface S33 is connected to the first side surface S31 and the second side surface S32, and the connection surface S33 is located farther away from the central axis CL than the first side surface S31 and the second side surface S32. In addition, the first side surface S31 has a structural region R3.

As shown in FIG. 15 to FIG. 17, the columnar protrusions E34 are disposed in the structural region R3 and arranged in a two-dimensional array. Moreover, the columnar protrusions E34 are arranged in a two-dimensional circular array.

As shown in FIG. 14, FIG. 18 and FIG. 19, the columnar protrusions E34 are connected to the structural region R3 and extend protrusively away from the structural region R3. In detail, each of the columnar protrusions E34 has a bottom part B3 and a top part T3 that are opposite to each other. A contour of each of the bottom parts B3 is circular-shaped, the bottom parts B3 are connected to the structural region R3, and each of the top parts T3 has an arcuate surface. In addition, a direction in which each of the columnar protrusions E34 extends from the structural region R3 is parallel to the central axis CL, and a surface of each of the columnar protrusions E34 is a smooth surface. Moreover, the top parts T3 of the columnar protrusions E34 of the third plastic lens element E3 are in physical contact with the optical element (the light-blocking element 13) adjacent thereto.

When the number of the columnar protrusions E34 is N1, the following condition is satisfied: N1=480×4=1920 (480 per ring, with a total of 4 rings).

As shown in FIG. 17, when a projected area of the structural region R3 on a plane perpendicular to the central axis CL is A1, and the number of the columnar protrusions E34 is N1, the following conditions are satisfied: A1=7.6619 mm²; N1=1920; and N1/A1=250.59 mm⁻².

As shown in FIG. 14, when an angle between a surface of the structural region R3 and the central axis CL is θ, the following conditions are satisfied: θ=90°; and sin θ=1.

As shown in FIG. 19, when a protrusion height of each of the columnar protrusions E34 in a direction parallel to the central axis CL is H1, and a distance between any two adjacent ones of the columnar protrusions E34 is P1, the following conditions are satisfied: H1=0.04 mm; P1=0.08 mm; and H1/P1=0.5.

### 2nd Embodiment

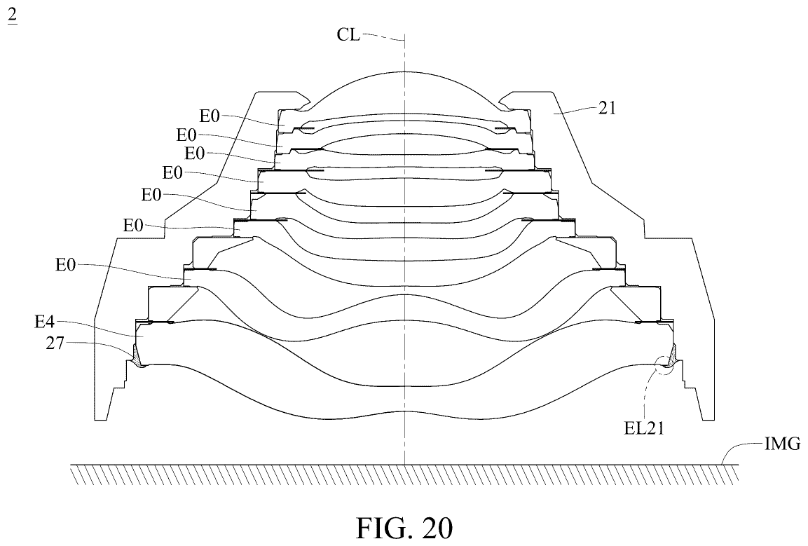

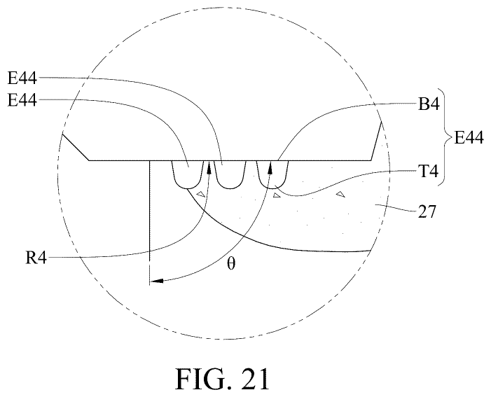

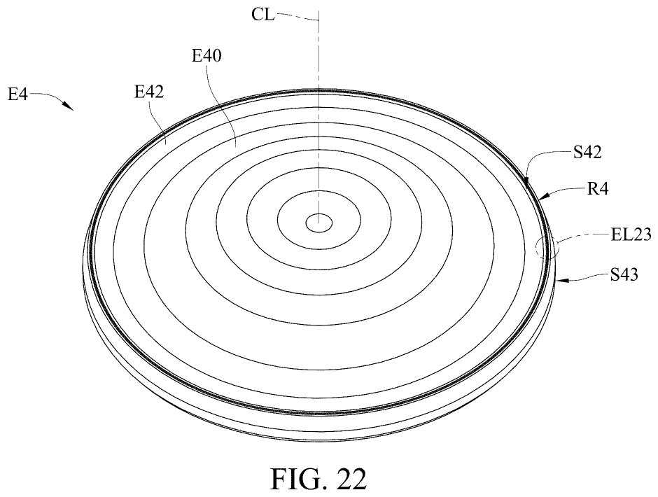

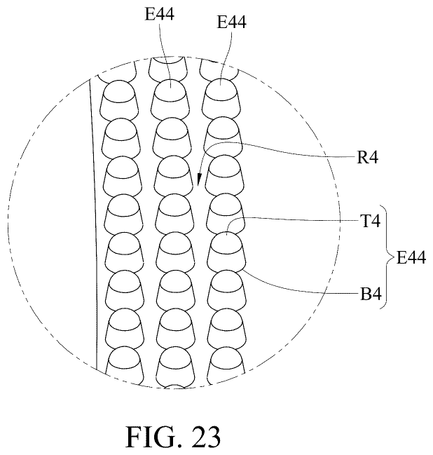

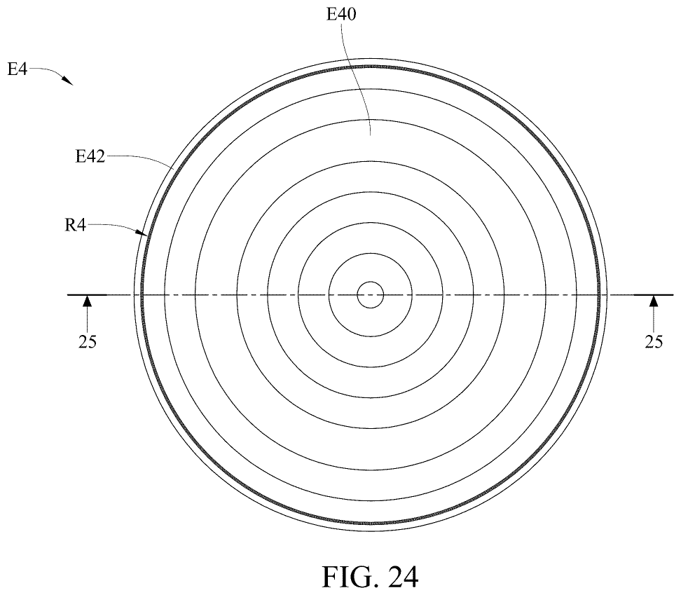

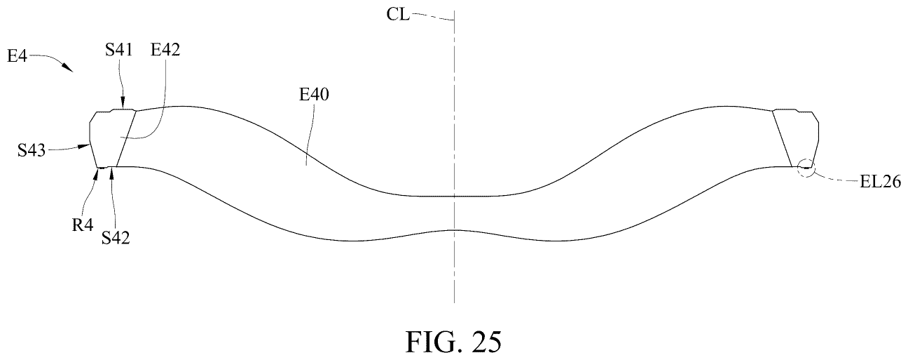

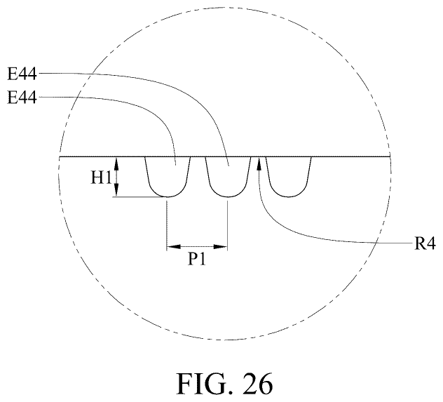

FIG. 20 is a cross-sectional view of an imaging lens according to the 2nd embodiment of the present disclosure, FIG. 21 is an enlarged view of region EL21 in FIG. 20, FIG. 22 is a perspective view of a plastic lens element in FIG. 20, FIG. 23 is an enlarged view of region EL23 in FIG. 22, FIG. 24 is a bottom view of the plastic lens element in FIG. 20, FIG. 25 is a cross-sectional view of the plastic lens element taken along line 25-25 in FIG. 24, and FIG. 26 is an enlarged view of region EL26 in FIG. 20.

An imaging lens 2 is provided in this embodiment. The imaging lens 2 includes a barrel 21, a plurality of lens elements E0 and E4, an adhesive element 27 and an image surface IMG. The lens elements E0 and E4 and the adhesive element 27 are accommodated in the barrel 21, and after entering the barrel 21, light passes through the lens elements E0 and E4 to form imaging light, which is then focused onto the image surface IMG.

The lens elements E0 and E4 include a plastic lens element E4, and the plastic lens element E4 is located closer to the image surface IMG than other lens elements E0 in the imaging lens 2.

The adhesive element 27 is in physical contact with the plastic lens element E4 and configured to secure the lens elements E0 and E4.

As shown in FIG. 22, FIG. 24 and FIG. 25, the plastic lens element E4 has a central axis CL, and the plastic lens element E4 includes an optically effective portion E40, a peripheral portion E42 and a plurality of columnar protrusions E44. In addition, the central axis CL passes through a center of the optically effective portion E40, and the peripheral portion E42 is adjacently disposed around the optically effective portion E40.

The peripheral portion E42 includes a first side surface S41, a second side surface S42 and a connection surface S43. The second side surface S42 is disposed opposite to the first side surface S41 in a direction parallel to the central axis CL. The connection surface S43 are connected to the first side surface S41 and the second side surface S42, and the connection surface S43 is located farther away from the central axis CL than the first side surface S41 and the second side surface S42. In addition, the second side surface S42 has a structural region R4.

As shown in FIG. 21 to FIG. 24, the columnar protrusions E44 are disposed in the structural region R4 and arranged in a two-dimensional array. Moreover, the columnar protrusions E44 are arranged in a two-dimensional circular array, and the columnar protrusions E44 are in physical contact with the adhesive element 27.

As shown in FIG. 21, FIG. 25 and FIG. 26, the columnar protrusions E44 are connected to the structural region R4 and extend protrusively away from the structural region R4. In detail, each of the columnar protrusions E44 has a bottom part B4 and a top part T4 that are opposite to each other. A contour of each of the bottom parts B4 is circular-shaped, the bottom parts B4 are connected to the structural region R4, and each of the top parts T4 has an arcuate surface. In addition, a direction in which each of the columnar protrusions E44 extends from the structural region R4 is parallel to the central axis CL, and a surface of each of the columnar protrusions E44 is a smooth surface.

When the number of the columnar protrusions E44 is N1, the following condition is satisfied: N1=720×3=2160 (720 per ring, with a total of 3 rings).

As shown in FIG. 24, when a projected area of the structural region R4 on a plane perpendicular to the central axis CL is A1, and the number of the columnar protrusions E44 is N1, the following conditions are satisfied: A1=3.6373 mm²; N1=2160; and N1/A1=593.85 mm⁻².

As shown in FIG. 21, when an angle between a surface of the structural region R4 and the central axis CL is θ, the following conditions are satisfied: θ=90°; and sin θ=1.

As shown in FIG. 26, when a protrusion height of each of the columnar protrusions E44 in a direction parallel to the central axis CL is H1, and a distance between any two adjacent ones of the columnar protrusions E44 is P1, the following conditions are satisfied: H1=0.02 mm; P1=0.03 mm; and H1/P1=0.66.

### 3rd Embodiment

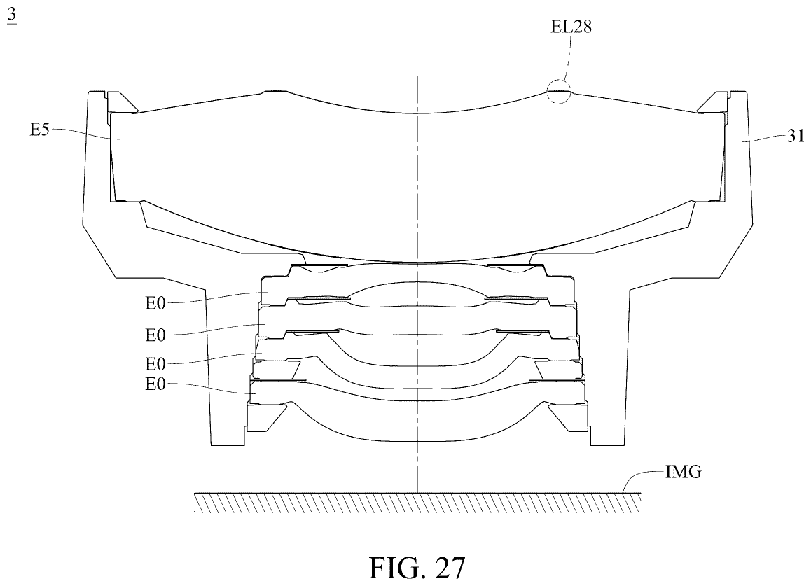

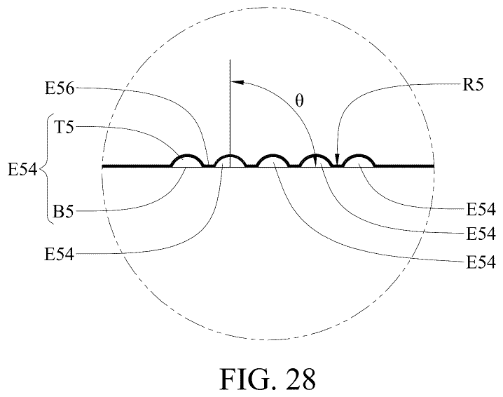

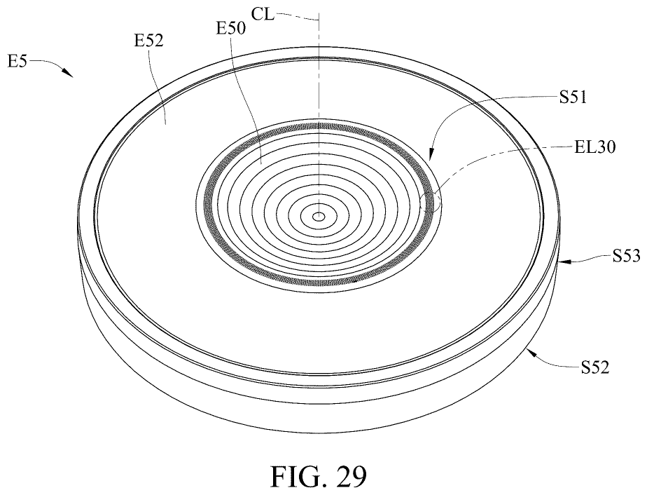

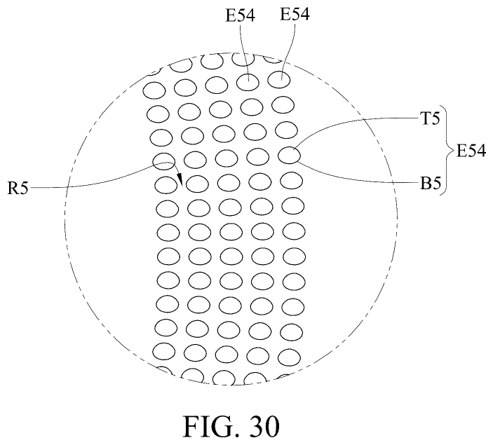

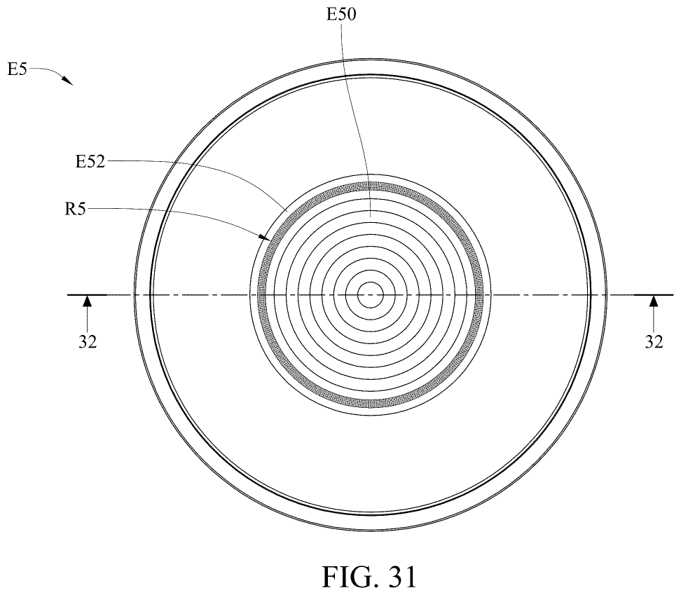

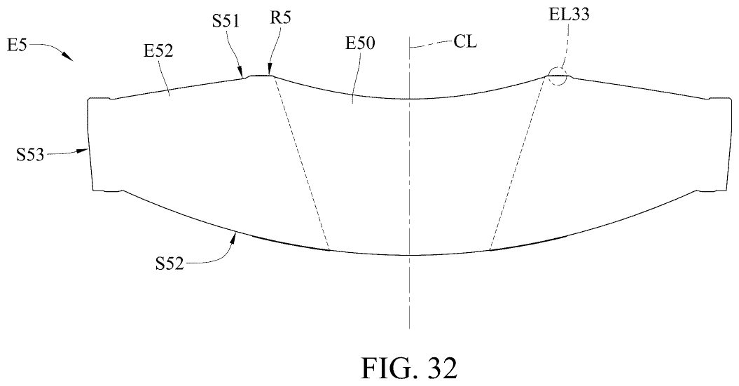

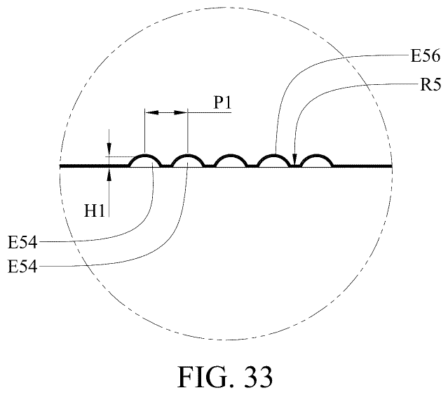

FIG. 27 is a cross-sectional view of an imaging lens according to the 3rd embodiment of the present disclosure, FIG. 28 is an enlarged view of region EL28 in FIG. 27, FIG. 29 is a perspective view of a plastic lens element in FIG. 27, FIG. 30 is an enlarged view of region EL30 in FIG. 29, FIG. 31 is a top view of the plastic lens element in FIG. 27, FIG. 32 is a cross-sectional view of the plastic lens element taken along line 32-32 in FIG. 31, and FIG. 33 is an enlarged view of region EL33 in FIG. 32. An imaging lens 3 is provided in this embodiment. The imaging lens 3 a barrel 31, a plurality of lens elements E0 and E5 and an image surface IMG. The lens elements E0 and E5 are accommodated in the barrel 31, and after entering the barrel 31, light passes through the lens elements E0 and E5 to form imaging light, which is then focused onto the image surface IMG.

The lens elements E0 and E5 include a plastic lens element E5, and the plastic lens element E5 is located closer to an imaged object than other lens elements E0 in the imaging lens 3.

As shown in FIG. 29, FIG. 31 and FIG. 32, the plastic lens element E5 has a central axis CL, and the plastic lens element E5 includes an optically effective portion E50, a peripheral portion E52, a plurality of columnar protrusions E54 and a light-absorbing coating E56. In addition, the central axis CL passes through a center of the optically effective portion E50, and the peripheral portion E52 is adjacently disposed around the optically effective portion E50.

The peripheral portion E52 includes a first side surface S51, a second side surface S52 and a connection surface S53. The second side surface S52 is disposed opposite to the first side surface S51 in a direction parallel to the central axis CL. The connection surface S53 are connected to the first side surface S51 and the second side surface S52, and the connection surface S53 is located farther away from the central axis CL than the first side surface S51 and the second side surface S52. In addition, the first side surface S51 has a structural region R5.

As shown in FIG. 29 to FIG. 31, the columnar protrusions E54 are disposed in the structural region R5 and arranged in a two-dimensional array. Moreover, the columnar protrusions E54 are arranged in a two-dimensional circular array.

As shown in FIG. 28, FIG. 32 and FIG. 33, the columnar protrusions E54 are connected to the structural region R5 and extend protrusively away from the structural region R5. In detail, each of the columnar protrusions E54 has a bottom part B5 and a top part T5 that are opposite to each other. A contour of each of the bottom parts B5 is circular-shaped, the bottom parts B5 are connected to the structural region R5, and each of the top parts T5 has an arcuate surface. In addition, a direction in which each of the columnar protrusions E54 extends from the structural region R5 is parallel to the central axis CL, and a surface of each of the columnar protrusions E54 is a smooth surface.

As shown in FIG. 28 and FIG. 33, the light-absorbing coating E56 covers the structural region R5 and the columnar protrusions E54, and the light-absorbing coating E56 is configured to reduce light reflection.

When the number of the columnar protrusions E54 is N1, the following condition is satisfied: N1=360×5=1800 (360 per ring, with a total of 5 rings).

As shown in FIG. 31, when a projected area of the structural region R5 on a plane perpendicular to the central axis CL is A1, and the number of the columnar protrusions E54 is N1, the following conditions are satisfied: A1=2.9992 mm²; N1=1800; and N1/A1=600.16 mm⁻².

As shown in FIG. 28, when an angle between a surface of the structural region R5 and the central axis CL is θ, the following conditions are satisfied: θ=90°; and sin θ=1.

As shown in FIG. 33, when a protrusion height of each of the columnar protrusions E54 in a direction parallel to the central axis CL is H1, and a distance between any two adjacent ones of the columnar protrusions E54 is P1, the following conditions are satisfied: H1=0.01 mm; P1=0.04 mm; and H1/P1=0.25.

### 4th Embodiment

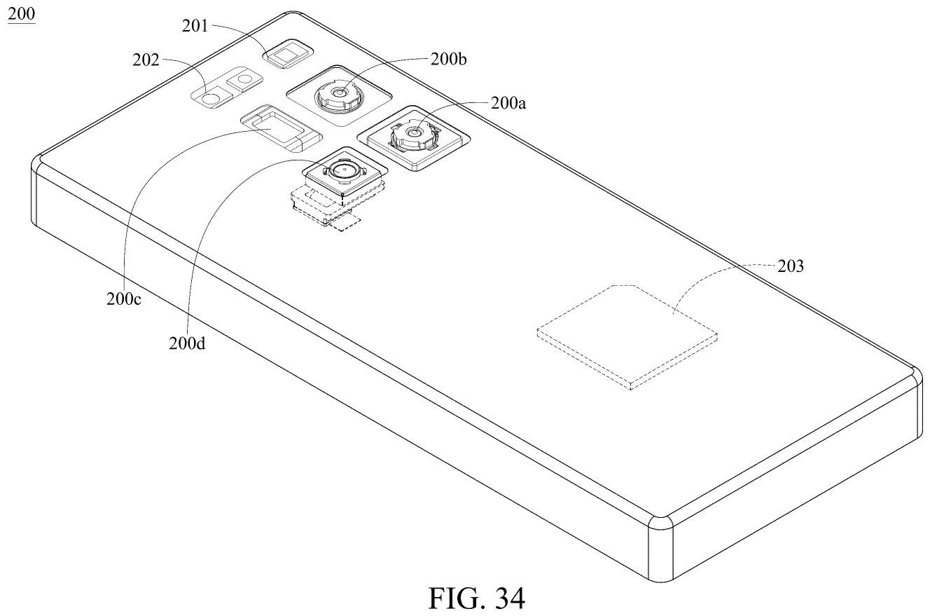

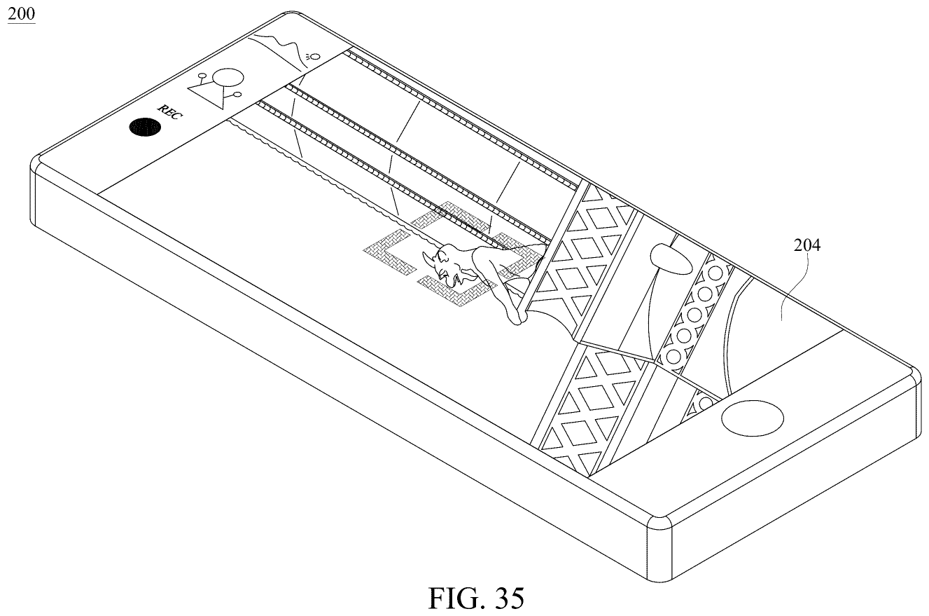

FIG. 34 is a perspective view of an electronic device according to the 4th embodiment of the present disclosure, and FIG. 35 is another perspective view of the electronic device in FIG. 34.

In this embodiment, the electronic device 200 is a smartphone including a plurality of camera modules, a flash module 201, a focus assist module 202, an image signal processor 203, a display module (user interface) 204, an image software processor (not shown) and an image sensor (not shown).

These camera modules include an ultra-wide-angle camera module 200a, a high pixel camera module 200b, a telephoto camera module 200c and a telephoto camera module 200d. Moreover, at least one of the camera modules 200a, 200b, 200c, and 200d can include the imaging lens of the present disclosure. The image sensor is disposed on the image surface of the imaging lens.

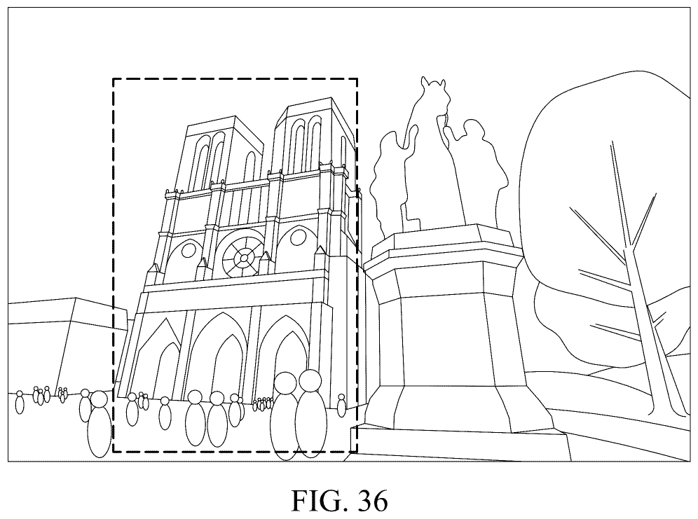

The image captured by the ultra-wide-angle camera module 200a enjoys a feature of multiple imaged objects. FIG. 36 is an image captured by the ultra-wide-angle camera module 200a.

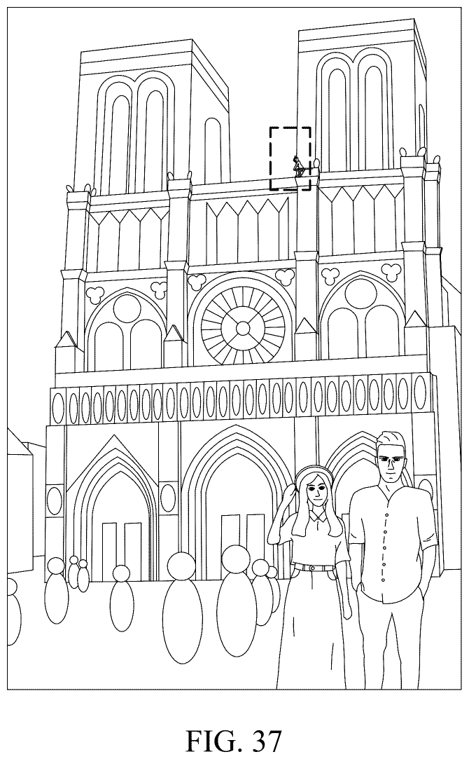

The image captured by the high pixel camera module 200b enjoys a feature of high resolution and less distortion, and the high pixel camera module 200b can capture part of the image in FIG. 36. FIG. 37 is an image captured by the high pixel camera module 200b.

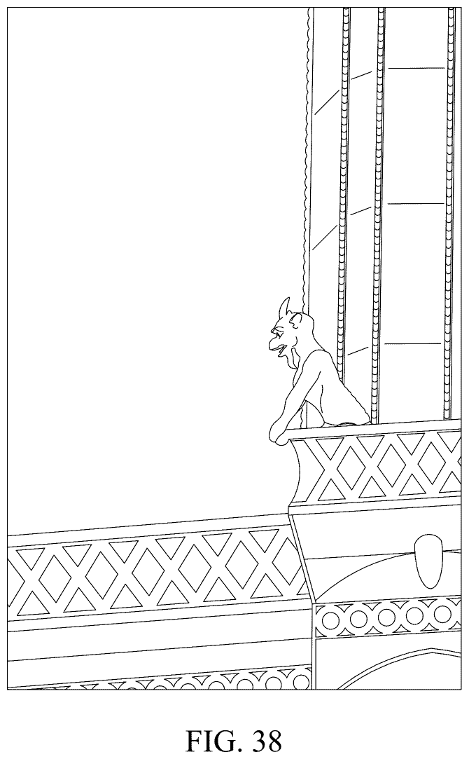

The image captured by the telephoto camera module 200c or the telephoto camera module 200d enjoys a feature of high optical magnification, and the telephoto camera module 200c or the telephoto camera module 200d can capture part of the image in FIG. 37. FIG. 38 is an image captured by the telephoto camera module 200c or the telephoto camera module 200d.

When a user captures images of an object, the light rays converge in the ultra-wide-angle camera module 200a, the high pixel camera module 200b, the telephoto camera module 200c or the telephoto camera module 200d to generate images, and the flash module 201 is activated for light supplement. The focus assist module 202 detects the object distance of the imaged object to achieve fast auto focusing. The image signal processor 203 is configured to optimize the captured image to improve image quality and provided zooming function. The light beam emitted from the focus assist module 202 can be either conventional infrared or laser. The display module 204 can include a touch screen, and the user is able to interact with the display module 204 to adjust the angle of view and switch between different camera modules, and the image software processor having multiple functions to capture images and complete image processing. Alternatively, the user may capture images via a physical button. The image processed by the image software processor can be displayed on the display module 204.

### 5th Embodiment

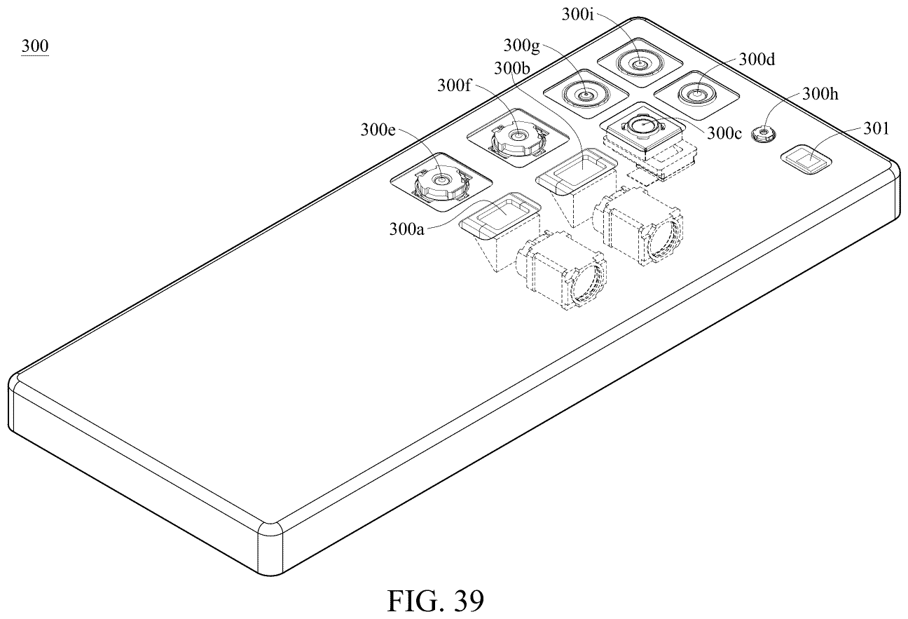

Please refer to FIG. 39, which is a perspective view of an electronic device according to the 5th embodiment of the present disclosure.

In this embodiment, the electronic device 300 is a smartphone including a camera module 300a, a camera module 300b, a camera module 300c, a camera module 300d, a camera module 300e, a camera module 300f, a camera module 300g, a camera module 300h, a camera module 300i, a flash module 301, an image signal processor, a display module, an image software processor (not shown) and an image sensor. The camera module 300a, the camera module 300b, the camera module 300c, the camera module 300d, the camera module 300e, the camera module 300f, the camera module 300g, the camera module 300h and the camera module 300i are disposed on the same side of the electronic device 300, while the display module is disposed on the opposite side of the electronic device 300. Moreover, at least one of the camera modules 300a, 300b, 300d, 300e, 300f, 300g, 300h, and 300i can include the imaging lens of the present disclosure. The image sensor is disposed on the image surface of the imaging lens.

The camera module 300a is a telephoto camera module, the camera module 300b is a telephoto camera module, the camera module 300c is a telephoto camera module, the camera module 300d is a telephoto camera module, the camera module 300e is a wide-angle camera module, the camera module 300f is a wide-angle camera module, the camera module 300g is a ultra-wide-angle camera module, the camera module 300h is a ToF (time of flight) camera module, and the camera module 300i is an ultra-wide-angle camera module. In this embodiment, the camera module 300i, the camera module 300a, the camera module 300b, the camera module 300c, the camera module 300d, the camera module 300e, the camera module 300f and the camera module 300g have different fields of view, such that the electronic device 300 can have various magnification ratios so as to meet the requirement of optical zoom functionality. In addition, the camera module 300a and camera module 300b are telephoto camera modules having a light-folding element configuration. In addition, the camera module 300h can determine depth information of the imaged object. In this embodiment, the electronic device 300 includes multiple camera modules 300a, 300b, 300c, 300d, 300e, 300f, 300g, 300h, and 300i, but the present disclosure is not limited to the number and arrangement of camera modules. When a user captures images of an object, the light rays converge in the camera module 300a, the camera module 300b, the camera module 300c, the camera module 300d, the camera module 300e, the camera module 300f, the camera module 300g, the camera module 300h or the camera module 300i to generate an image(s), and the flash module 301 is activated for light supplement. Further, the subsequent processes are performed in a manner similar to the abovementioned embodiments, so the details in this regard will not be provided again.

### 6th Embodiment

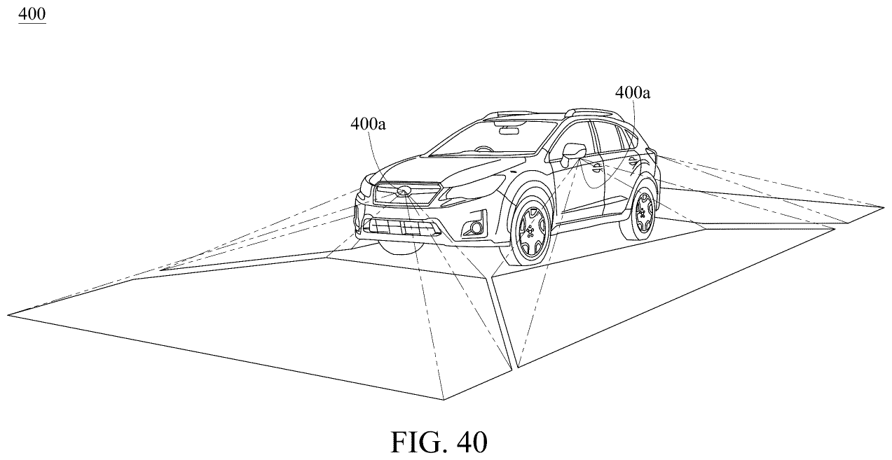

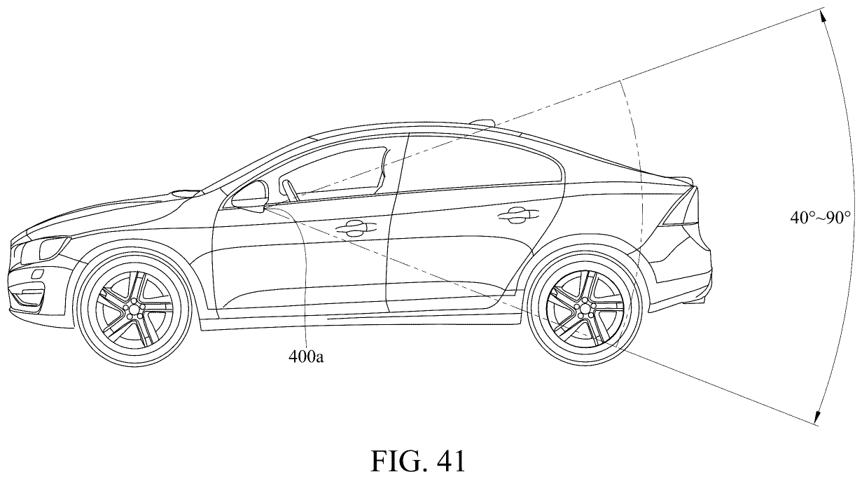

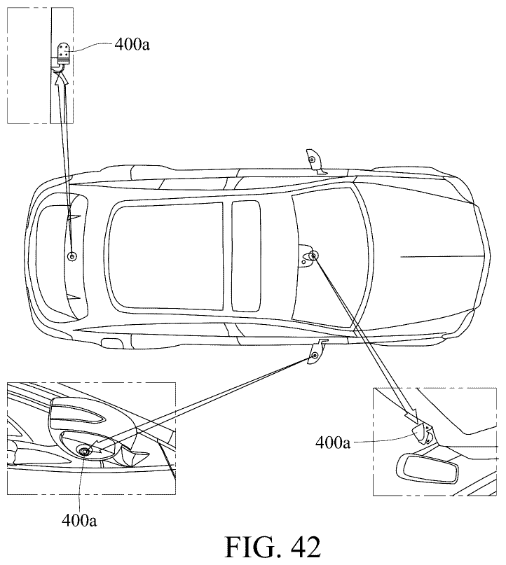

FIG. 40 is a perspective view of an electronic device according to the 6th embodiment of the present disclosure, FIG. 41 is a side view of the electronic device in FIG. 40, and FIG. 42 is a top view of the electronic device in FIG. 40.

In this embodiment, the electronic device 400 is an automobile. The electronic device 400 includes a plurality of automotive camera modules 400a and image sensors (not shown), and the camera modules 400a each include the imaging lens of the present disclosure. The camera modules 400a can serve as, for example, panoramic view car cameras, dashboard cameras and vehicle backup cameras. The image sensors are disposed on the image surfaces of the imaging lenses.

As shown in FIG. 40, the camera modules 400a are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 41, the camera modules 400a are, for example, respectively disposed on the lower portion of the side mirrors. A maximum field of view of the camera modules 400a can be 40 degrees to 90 degrees for capturing images in regions on left and right lanes.

As shown in FIG. 42, the camera modules 400a can also be, for example, respectively disposed on the lower portion of the side mirrors and inside the front and rear windshields for providing external information to the driver, and also providing more viewing angles so as to reduce blind spots, thereby improving driving safety.

The smartphones, panoramic view car cameras, dashboard cameras and vehicle backup cameras in the embodiments are only exemplary for showing the imaging lens of the present disclosure installed in an electronic device, and the present disclosure is not limited thereto. The imaging lens can be optionally applied to optical systems with a movable focus. Furthermore, the imaging lens features good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens comprising:
a plastic lens element having a central axis, and the plastic lens element comprising:
an optically effective portion, wherein the central axis passes through a center of the optically effective portion; and
a peripheral portion adjacently disposed around the optically effective portion, and the peripheral portion comprising:
a first side surface;
a second side surface disposed opposite to the first side surface in a direction parallel to the central axis; and
a connection surface connected to the first side surface and the second side surface, and the connection surface being located farther away from the central axis than the first side surface and the second side surface;
wherein at least one of the first side surface and the second side surface has a structural region, the plastic lens element further comprises a plurality of columnar protrusions, the plurality of columnar protrusions are disposed in the structural region and arranged in a two-dimensional array, the plurality of columnar protrusions are connected to the structural region and extend protrusively away from the structural region, each of the plurality of columnar protrusions has a bottom part and a top part that are opposite to each other, a contour of each of the bottom parts is circular-shaped, the bottom parts are connected to the structural region, and each of the top parts has an arcuate surface; and
wherein a projected area of the structural region on a plane perpendicular to the central axis is A1, a number of the plurality of columnar protrusions is N1, and the following condition is satisfied:
$$250 {mm}^{- 2} < N 1 / A 1 < 1500 {mm}^{- 2} .$$

2. The imaging lens of claim 1, wherein the projected area of the structural region on the plane perpendicular to the central axis is A1, the number of the plurality of columnar protrusions is N1, and the following condition is satisfied:
$$450 {mm}^{- 2} < N 1 / A 1 < 1100 {mm}^{- 2} .$$

3. The imaging lens of claim 2, wherein the projected area of the structural region on the plane perpendicular to the central axis is A1, the number of the plurality of columnar protrusions is N1, and the following condition is satisfied:
$$500 {mm}^{- 2} < N 1 / A 1 < 800 {mm}^{- 2} .$$

4. The imaging lens of claim 1, wherein the number of the plurality of columnar protrusions is N1, and the following condition is satisfied:
$$746 < N 1 < 4500 .$$

5. The imaging lens of claim 4, wherein the number of the plurality of columnar protrusions is N1, and the following condition is satisfied:
$$783 < N 1 < 2330 .$$

6. The imaging lens of claim 5, wherein the number of the plurality of columnar protrusions is N1, and the following condition is satisfied:
$$814 < N 1 < 1513 .$$

7. The imaging lens of claim 1, wherein an angle between a surface of the structural region and the central axis is θ, and the following condition is satisfied:
$$0.86 < sin θ \leq 1.$$

8. The imaging lens of claim 7, wherein the angle between the surface of the structural region and the central axis is θ, and the following condition is satisfied:
$$0.96 < sin θ \leq 1.$$

9. The imaging lens of claim 7, wherein a protrusion height of each of the plurality of columnar protrusions in a direction parallel to the central axis is H1, a distance between any two adjacent ones of the plurality of columnar protrusions is P1, and the following condition is satisfied:
$$0.2 < H 1 / P 1 < 0.8 .$$

10. The imaging lens of claim 9, wherein the protrusion height of each of the plurality of columnar protrusions in the direction parallel to the central axis is H1, the distance between any two adjacent ones of the plurality of columnar protrusions is P1, and the following condition is satisfied:
$$0.4 < H 1 / P 1 < 0.67 .$$

11. The imaging lens of claim 7, wherein a direction in which each of the plurality of columnar protrusions extends from the structural region is parallel to the central axis.

12. The imaging lens of claim 1, further comprising an optical element, wherein the optical element is disposed adjacent to the plastic lens element, and the top parts of the plurality of columnar protrusions are in physical contact with the optical element.

13. The imaging lens of claim 1, wherein the plastic lens element further comprises a light-absorbing coating covering the structural region and configured to reduce light reflection.

14. The imaging lens of claim 1, wherein a surface of each of the plurality of columnar protrusions is a smooth surface.

15. The imaging lens of claim 1, further comprising an adhesive element configured for securing the plastic lens element, wherein the plurality of columnar protrusions are in physical contact with the adhesive element.

16. An electronic device comprising:
the imaging lens of claim 1; and
an image sensor disposed on an image surface of the imaging lens.
